(19) United States
(12) Patent Application Publication
(10) Pub. No.: US 2025/0285638 A1
(43) Pub. Date: Sep. 11, 2025

(54) INTELLIGENT AREA-BASED SOUND SOURCE SEPARATION

(71) Applicant: Microsoft Technology Licensing, LLC, Redmond, WA (US)

(72) Inventors: Okan KÖPÜKLÜ, Munich (DE); Martin Korbinian Heinrich STRAUSS, Nuremberg (DE); Maria LUIS VALERO, Munich (DE)

(73) Assignee: Microsoft Technology Licensing, LLC, Redmond, WA (US)

(21) Appl. No.: 18/597,658

(22) Filed: Mar. 6, 2024

(51) Int. Cl. G10L 21/028; G10L 21/0208; G10L 21/0216

(52) U.S. Cl. CPC G10L 21/028; G10L 21/0216; G10L 2021/02087; G10L 2021/02166

(57) ABSTRACT

Real-time source separation is desirable for its ability to clearly transmit desired audio signals but is computationally costly when applied across large areas. Thus, a tradeoff between sound source separation quality and system performance is presented. For that reason, this disclosure of area-based sound source separating techniques resolves this tradeoff. Concepts herein include an area-based sound source separating machine learning architecture defines subareas and redefines those subareas as necessary to capture desired audio signal(s). By redefining the subarea, less noise or unwanted audio signals are received/processed, significantly reducing computational resources while increasing throughput of the desired audio signal(s).

### BACKGROUND

Sound source separation is characterized by extracting individual sources of audio signals from a mixture of audio signals. There exists a wide range of different approaches for sound source separation, which either operate directly on the audio waveform or focus on the signal information in the frequency domain. However, existing approaches require significant computational resources. In addition, the use of multiple microphones to capture the audio mixture allows for the application of spatial filtering techniques that exploit spatial information (such as the time-difference-of-arrival with respect to the microphones approaches).

Similar to sound source separation, beamforming techniques have been studied for a long time with the aim of enhancing a signal of interest coming from a certain direction while suppressing interfering and background noise sources. This is achieved by leveraging the spatial information to “steer” the beamformer towards the signal of interest. The most popular beamforming approaches are the following methods: Delay-Sum, General Side-Lode Canceller (GSC), Linearly-Constrained Minimum Variance (LCMV), Superdirective, and Minimum Variance Distortionless Response (MVDR).

### SUMMARY

Aspects of the present application relate to real time sound extraction devices, systems, and methods. In this manner, these concepts disclosed herein can adaptably define a target area within a coverage area and use the target area within the coverage area to extract sound from the remainder of the coverage area while adjusting the target area toward an active sound source when necessary. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method for extracting sound from a coverage area is disclosed. The method can include receiving speech signals from one or more audio sources in a plurality of audio sources within the coverage area. The method can also include defining a target area that is a portion of the coverage area, the target area being definable by a trained criterion. The method can furthermore include redefining the target area to include the speech signals during a processing operation such that there is negligible additional computational cost. The method can in addition include extracting the speech signals from the target area. The method can moreover include transmitting the speech signals to a receiver. Other examples of this aspect include corresponding computer systems, apparatus, and computer programs recorded on one or more computer storage devices, each configured to perform the actions of the methods.

In another general aspect, a system can include one or more computing systems, each of the computing systems having: a processor; a storage in communication with the processor; and a plurality of audio input devices. The system can also include the one or more computing systems being configured to: receive speech signals from one or more audio sources in a plurality of audio sources within the coverage area; define a target area that is a portion of the coverage area, the target area being definable by a trained criterion; redefine the target area to include the speech signals during a processing operation such that there is negligible additional computational cost; extract the speech signals from the target area; and transmit the speech signals to a receiver. Other examples of this aspect include corresponding computer systems, apparatus, and computer programs recorded on one or more computer storage devices, each configured to perform the actions of the methods.

In yet another general aspect, a computer-readable medium is disclosed. The computer-readable medium can access instructions that, when executed by one or more processors, cause a system to perform processes for extracting sound from a coverage area having a system with at least one audio input device. An example process can include receiving speech signals from one or more audio sources in a plurality of audio sources within a coverage area. The process can include defining a target area that is a portion (or subarea) of the coverage area, the target area being definable by a trained criterion. The process can include redefining the target area to include the speech signals during a processing operation such that there is negligible additional computational cost. The process can include extracting the speech signals from the target area and transmitting the speech signals to a receiver. Other examples of this aspect include corresponding computer systems, apparatus, and computer programs recorded on one or more computer storage devices, each configured to perform the actions of the methods.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a schematic view of an example scenario in which principles of the present disclosure may be particularly useful according to aspects of the disclosure.

FIG. 2A is illustrative of an exemplary target area with the system of FIG. 1 having multiple microphones according to aspects of the disclosure.

FIG. 2B is illustrative of an exemplary target area situated around a particular active speaker according to aspects of the disclosure.

FIG. 2C is illustrative of an exemplary target area that had been steered from the position shown in FIG. 2B to focus on another active speaker according to aspects of the disclosure.

FIG. 2D is illustrative of another exemplary target area that is wider than the target areas shown in FIGS. 2B and 2C according to aspects of the disclosure.

FIG. 2E is illustrative of relocating a target area from an existing area to a new area.

FIG. 2F is illustrative of an exemplary target area that has been increased compared to FIG. 2B according to aspects of the disclosure.

FIG. 3 is a schematic view of the system of FIG. 1 in communication with an external system according to aspects of the disclosure.

FIG. 4 is a flow chart of a method according to the concepts of moving or redefining a target area as contemplated by this disclosure.

FIG. 5 is a flow chart of a method according to aspects of the disclosure.

FIG. 6 illustrates two separate stages of information related to redefining a target area, which can be used to train a DNN according to aspects of the disclosure.

FIG. 7 is a diagram of power reduction heatmaps of the trained DNN at three stages according to aspects of the disclosure.

FIG. 8 is a table showing DNSMOS and SI-SDR results (mean) for the test scenarios according to aspects of the disclosure.

FIG. 9 is a plot of power reduction performance of three different DNN models at different steering angles according to aspects of the disclosure.

FIG. 10 is a diagram of another stage with which can further be used to train a DNN according to aspects of the disclosure.

FIG. 11 is a table of different test scenarios with a mixture of target t and interfering sources k according to aspects of the disclosure.

FIG. 12 is a table comparing employed models over a number of parameters, computational complexity (GFLOPs), and real-time factor according to aspects of the disclosure.

FIG. 13 is a power reduction heatmap of a target area with α=600 using a trained DNN according to aspects of the disclosure.

FIG. 14 is a table of DNSMOS and SI-SDR results (mean) for test scenarios with a different number of speakers and with or without background noise according to aspects of the disclosure.

FIG. 15 is a table of ΔOVRL (mean±std) of DNSMOS for different SIRs using 1 target and 1 interfering speaker without noise source according to aspects of the disclosure.

FIG. 16 is a table of ΔOVRL (mean±std) of DNSMOS for different SIRs using multiple target and interfering speaker without noise source according to aspects of the disclosure.

FIG. 17 is a block diagram illustrating example physical components of a computing device with which aspects of the disclosure may be practiced.

FIG. 18 is a simplified block diagram of a computing device with which aspects of the present disclosure may be practiced.

FIG. 19 is a simplified block diagram of a distributed computing system in which aspects of the present disclosure may be practiced.

### DETAILED DESCRIPTION

The present disclosure generally relates to extracting desired audio information from a mixture of audio signals and, in particular, to audio information or audio signal extraction using sound source separation and beamforming techniques. For instance, disclosed herein are devices, systems, and methods relating to redefining a target area that enable an area-based sound source separating machine learning architecture (e.g., a deep neural network and the like) to “steer” its target area, also referred to as redefining the target area, to a new desired direction. By redefining the target area, less noise or unwanted audio signals are received/processed, increasing throughput of the desired audio signal(s).

Real-time source separation, as discussed herein, is especially valuable in the context of virtual meetings where intended speech quality can suffer from interfering speech and/or background noise. However, without concepts described herein, the pre-existing processes are resource-intensive tasks that compromise system performance during operation. The issue grows in complexity if the source of the intended speech moves or changes to a different source. It is therefore advantageous to provide an architecture that adaptably defines a target area within a coverage area using a target area within the coverage area to extract sound from the remainder of the coverage area while adjusting the target area toward an active sound source when necessary.

Microphones enable many types of audio recording devices for purposes including communications of many kinds, as well as music vocals, speech and sound recording. Microphones are audio input devices that translate sound vibrations in the air into electronic signals and captures them to a recording medium and/or transmits them to other devices (e.g., a loudspeaker). Microphones can be standalone or embedded in devices such as headsets and laptops. In practice, a variety of microphone designs exist, each of which have advantages and disadvantages. How a microphone works varies depending on the purpose of its design. Primary considerations include the type of device, what is being recorded, and the directionality of microphones. Microphones may be dynamic in that they may use a coil suspended in a magnetic field that may be attached to multiple membranes for extended frequency response. Dynamic microphones use electrical energy in the form of induction to produce the audio signal. A capsule of the microphone contains a small diaphragm connected to a moving coil such that the diaphragm moves when it is hit by soundwaves. This action causes the coil to move back and forth in the magnet's field, generating an electrical current.

Most audio input devices and, thus, speech signal receiving systems operate in noisy environments. Under these circumstances, desired speech signals are corrupted by interfering signals such as noise sources and interfering or competing speakers. These speech signals are further distorted by environmental reverberations. In many applications, there is a need to separate the multiple sources or extract a source of interest while minimizing undesired interfering signals and noise. The estimated signals may then be either directly listened to or further processed. In general, audio processing will improve captured speech signals. Audio processing can be performed through filtering away noise, amplifying background noise, or representing the signal in an intuitive way.

While humans naturally separate one speech signal source of interest in noisy environments (e.g., a cocktail party environments), enabling machines to do similar functions remains a challenge. Humans are naturally bidirectional receivers due to having oppositely positioned ear. It follows that it is difficult to improve both intelligibility and quality of captured speech signals at the same time using only a single channel. Improvements can be made by adding spatial information to the time/frequency information available in the single channel case using multichannel (e.g., two or more channels) to capture noisy speech signals. These speech signals can then be processed to be particularly useful in a desired application.

Known are two main categories of multichannel (microphone array) algorithms: Source separation and Beamforming. Source separation is often referred to as blind source separation (or “BSS”) because it estimates source signals using only information about their mixtures as observed in each input channel. So, BSS operates uninformed of any information about each source (e.g., its frequency characteristics and location) or how the sources are mixed. On the other hand, beamforming (or “BF”) enhances a sum of the desired sources while treating all other signals as interfering sources. This action is accomplished via one or more algorithms.

A beamformer is a signal processor used together with a microphone array to provide the capability of spatial filtering. The microphone array produces spatial samples of the propagating wave, which are then manipulated by the signal processor to produce the beamformer output signal. Beamforming is accomplished by filtering the microphone signals and combining the outputs to extract (by constructive combining) the desired signal and reject (by destructive combining) interfering signals according to their spatial location. Beamforming can separate sources with overlapping frequency content that originate at different spatial locations. Delay-and-Sum-beamforming is a commonly used sound localization technique. At its core, this beamforming technique principally relies on the fact that a mixed sound of different point sources requires different amounts of time to reach the same array microphones. And by calculating this time differences between sounds and each microphone of an array, direction and strength of sound sources can determined. This determination can be used in beamforming as sound source localization to direct (or steer) beams.

Combining BSS and BF can be accomplished via time-frequency masking, which generates a time-frequency representation of speech signals. This masking (e.g., filtering mixed signals) can be accomplished using a Short Time Fourier Transform (STFT). Computing STFTs divides longer time signals into shorter segments of equal length for determining a Fourier transform separately on each shorter segment. The STFT reveals the Fourier spectrum on each shorter segment. An STFT allows use of information about the signal's frequency content and the variations of its content over time. This is advantageous because all time related information is lost while performing BSS in frequency domain.

Calculating STFTs can be resource intensive. In general, a noisy speech signal first undergoes T-F analysis, resulting in a T-F representation. A separation algorithm then operates on the representation, and the outcome of the separation is a T-F mask. Then a synthesis is performed to convert separated speech and background noise from the T-F representation back to the waveform representation. The STFT is evaluated over a sample window length, which affects a Signal to Interference Ratio during BSS. In computing, the STFT window length presents a trade-off between time and frequency resolution. A short window (e.g., from about 15 to 25 ms) allows easy identification of precise times at which a signal changes but it is difficult to identify precise frequencies. On the other hand, a long window (e.g., 800-1200 ms) allows easy identification of frequencies but blurs the time between frequency changes. So, the window size of the STFT can be adjusted to maximize separation quality for a given source or combination of sources. This means using both longer and shorter windows together in same process produces features with different time-frequency resolutions that are useful in audio signal processing.

These methods can be improved upon by taking advantage of current advancements in artificial intelligence to improve reliability and accuracy of audio processing. Machine learning (ML) is the ability of a system to learn a task from data, then generalize the result and apply the task to new data. Machine learning models can separate mixed signals into their individual sources using deep learning, which involves the use of neural networks to model and solve complex problems. Neural networks are modeled after the structure and function of the human brain and consist of layers of interconnected nodes that process and transform data. And as alluded to above, humans perform very well at the cocktail party problem to focus on a single speaker while filtering out other voices and background noise.

Deep Learning is the use of deep neural networks, which have multiple layers of interconnected nodes. These networks can learn complex representations of data by discovering hierarchical patterns and features in the data. Deep Learning algorithms can “automatically” learn and improve from data without needing human intervention or manual feature engineering. Training deep neural networks typically requires a large amount of data and computational resources. However, the availability of cloud computing and the development of specialized hardware, such as Graphics Processing Units (GPUs), has made it easier to train DNNs.

Responsiveness of a DNN can be directly proportional to the amount of inference time required for operation. In deep learning, inference time is the amount of time it takes for a machine learning model to process new data and make a prediction. It follows that inference optimization is an important measure to enhance efficiency and speed of DNNs, impacting their practical usability and performance, especially in real-world applications. For instance, an inference time of around or less than 1 second is generally considered responsive. DNN inference requires high computation power, which can be performed slower locally or faster via a cloud infrastructure in most scenarios. In this light, some systems locally run inference every 30-60 seconds to maintain a responsive operation without continuously bogging down computational resources.

A convolutional neural network (CNN) is a type of deep neural network that is most often applied to analyze and learn visual features from large amounts of data. CNN development is a three-step process, which includes training the model, optimizing the model, and deploying the model to run inference. CNNs can be deployed for use in natural language processing and in recommendation engines and are especially useful in image processing. CNNs process large amounts of data in a grid format and then extract important granular features for classification and detection using three types of layers: a convolutional layer, a pooling layer, and a fully connected layer. CNNs typically have multiple convolutional layers that apply filters to the input data and learn feature detections. Early convolutional layers extract general or low-level features, such as lines and edges, while the later layers learn finer details or high-level features. Pooling layers are applied to decrease the size of the convolutional feature maps to reduce the computational costs. Fully connected layers learn global patterns based on the high-level features output from the convolutional and pooling layers and generate the global patterns. Once the input data is passed through the fully connected layer and the neural network issues its predictions. Each layer serves a different purpose, performs a task on ingested data, and learns increasing amounts of complexity.

In sum, potential solutions contemplated herein relate to extracting speech signals (e.g., desired audio signals from particular individuals or participants in a meeting) include beamforming and sound source separation techniques. Beamforming techniques enhance a speech signal of interest coming from a certain direction while suppressing interfering and background noise sources. This is achieved by leveraging spatial information to steer the beamformer toward the signal of interest. Popular beamforming approaches include Delay-Sum, General Side-Lode Canceller (GSC) and Linearly-Constrained Minimum Variance (LCMV) beamformer, along with its variants, the Superdirective and Minimum Variance Distortionless Response (MVDR) beamformers. Beamforming algorithms often require feature decomposition of spatial covariance matrices, so the amount of calculation is relatively large. Source separation has a wide range of different approaches, including operating directly on the audio waveform or in the frequency domain. In addition, the usage of multiple microphones to capture the audio mixture allows for the application of spatial filtering techniques exploiting additional information such as the time-difference-of-arrival with respect to the microphones. Each of these techniques are capable of retaining all speech utterances from the meeting participants, while suppressing all interfering sounds.

With this in mind, principles of the present disclosure have two objectives. First, all speech utterances within a defined target area need to be captured to ensure all participants' speech signals are covered. Second, employed solutions should be real-time capable preventing unwanted delays. Taking a step further, this target area should not be rigid, but rather dynamically adaptable to other directions that potentially allows for others in the meeting to be included, but also for intentional muting of individuals by not including them in the target area.

Disclosed herein are devices, systems, and methods to reliability and efficiently extract sound with minimal delay. Blending aspects of beamforming and source separation, principles of the present disclosure exclusively extract sound or mute sound at a low computational cost by adaptively defining a subarea (also referred to herein as a “target area”) around localized speech signals of interest. To that end, a machine learning model can be trained to define an initial target area (e.g., a subarea of a coverage area) and to redefine the target area when necessary. This process can be similar to steering a beam during beamforming. For example, redefining the target area may be necessary to better define the subarea and/or to redefine the subarea as localization of speech signals of interest changes. Thereby, the real-time processing capability of the trained models is preserved.

With the target area defined, the machine learning algorithm can extract and capture mixed audio from the target area for processing the speech signals. In general, a system with audio input device(s) can capture mixed signals from the air, capturing or retaining all speech signals from the coverage area. Knowing the target area, the machine learning model can perform a source-separation type process where speech signals are separated from the captured mixed signals. Contrary to traditional source separation, this source-separation type process leverages information from defining the target area to thereby operate with localization information about the source signals and/or about the mixing process of the mixed signals. These principles are appropriate for numerous scenarios, including meetings with multiple target areas, interfering speech signals, and disturbing background noises. The proposed approach outperforms widely known beamforming baselines in terms of Deep Noise Suppression Mean Opinion Score (DNSMOS) and scale-invariant signal-to-distortion ratio (SI-SDR).

Example implementations can spotlight a mobile speaker moving around the coverage area. Sequentially, the machine learning model can use polar coordinates to define an initial target area that is centered about a center of the microphone array. This target area can initially include a speaker who is at a first location and apply phase shifts to redefine the target area to include the speaker at second, third, and fourth locations, each of which is different from the other. Rather than triggering an inference event for the machine learning model themselves, phase shifts can be performed during existing or predicted inference events of the machine learning model (sometimes exclusively) to have a negligible additional computational cost.

In more detail, with the above as foundation, the following discussion relates to particular machine learning models that employ principles of the present disclosure. To begin, source separation-type process uses a uniform linear array (ULA) formed with M∈N⁺ microphones placed at random locations in a room (e.g., a coverage area). A complex valued Fourier spectrum of an audio mixture Y(t, f)∈C^{M} is expressed as the summation of a target signal Xₜ(t, f)∈C^{M}, an interfering signal Xᵢ(t, f)∈C^{M} and background noise N(t, f)∈C^{M} in the STFT domain, e.g.,

$$Y ( t , f ) = {X}_{t} ( t , f ) + {X}_{i} ( t , f ) + N ( t , f ) , \qquad ( 1 )$$

where t and f denote the time frame and frequency bin. The target area is spanned by an angle α in front of the microphone array with the center of the microphone array as origin. The target signal spectrum Xₜ(t, f) is determined by the summation of all speech signals inside the target area, i.e.,

$${X}_{t} ( t , f ) = {\sum }_{r = 1}^{R} {X}_{t , r} ( t , f ) \qquad ( 2 )$$

where r∈[1, . . . , R] is the speaker index. All interfering sources Xᵢ(t, f) are defined as the combination of speech sources outside of the target area, i.e.,

$${X}_{i} ( t , f ) = {\sum }_{j = 1}^{J} {X}_{i , j} ( t , f ) \qquad ( 3 )$$

with speaker index j∈[1, . . . , J]. The background noise can be located inside or outside the target area. Given this acoustic step, the goal is to estimate a mask Q∈C^{T×F×1} to separate the target estimate \hat{X}ₜ(t, f)∈C from the input signal by an element wise multiplication to the reference microphone signal, i.e.,

$${\hat{X}}_{t} ( t , f ) = Q ⊙ {Y}_{m = 1} . \qquad ( 4 )$$

For discussion purposes only, the number of microphones is set to be M=2 with the left microphone representing the reference. While a target area can be refined by training the DNN to look for and deploy every potential target area (similar to beamforming), it is computationally costly. On the other hand, as discussed above, applying a phase shift at inference time to the STFT representation of the second microphone can redefine the target area at a low computational cost. In this regard, the inter microphone phase difference Δ is defined as follows:

$$Δφ = 2 π f \frac{d}{c} cos θ , \qquad ( 5 )$$

where f denotes the frequency, d denotes the distance between the two microphones and c the speed of sound. Assuming a far field scenario, the angle θ denotes the incident angle of sound waves reaching the microphones. Considering the phase difference between two target areas and assuming the incident angle of the first target area is θ₁=90, redefining the new target area results in multiplying the STFT representation of the second microphone to the DNN with a vector a∈C^{F}, where F symbolizes the number of frequencies, i.e.,

$$a ( f ) = {e}^{j ( Δφ1 - Δφ2 )} = {e}^{j 2 π f ( \frac{d}{c} ) ( cos {θ}_{1} - cos {θ}_{2} )} \qquad ( 6 )$$

$$θ = 90 ° = {e}^{- j2 π f ( \frac{d}{c} ) cos {θ}_{2}} \qquad ( 7 )$$

Assuming stereo input sound, the vector a is multiplied to the second microphone signal in STFT domain, i.e.,

$${\hat{Y}}_{m = 2} ( t , f ) = a ( f ) {Y}_{m = 2} ( t , f ) . \qquad ( 8 )$$

It should be noted that the dependency on θ leads to a nonlinear change in the target area depending on the redefining angle, which is neglected here for simplicity.

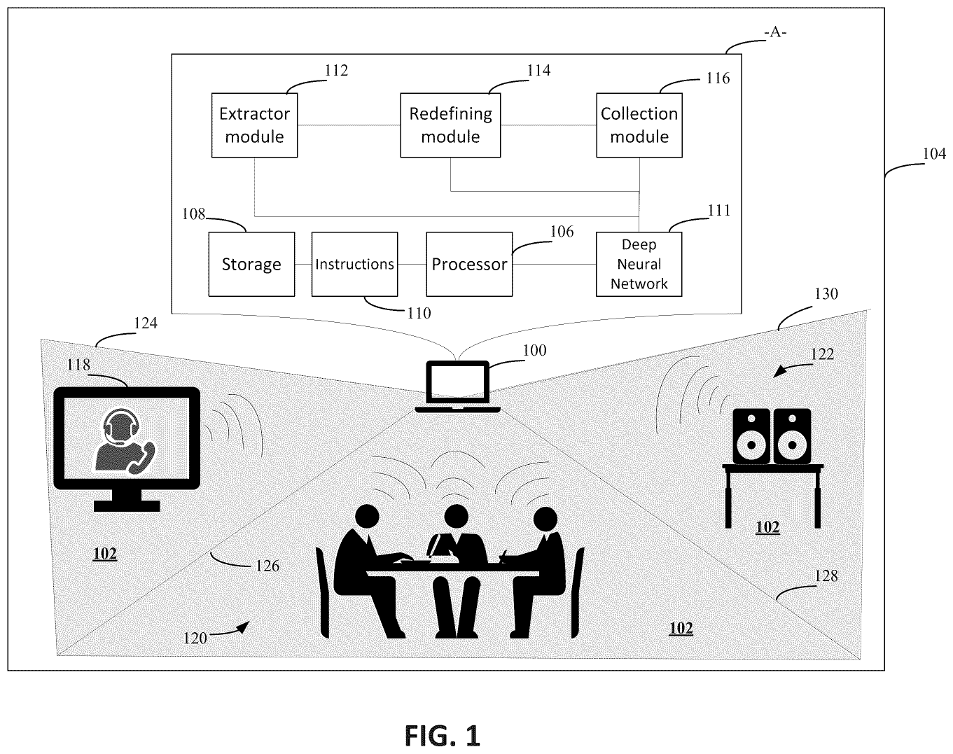

FIG. 1 shows an example scenario in which principles of the present disclosure may be particularly useful. Illustrated is a system 100 for extracting sounds from a target area 102 within a coverage area 104 with multiple sound sources situated therein. Any portion of the coverage area 104 that is not included in the target area 102 is referred to as a nontarget area (e.g., coverage area 104 minus target area 102 equals nontarget area). In an example, the system 100 extracts sound from a target area 102 that is a portion (e.g., a fraction or all) of the coverage area 104. Under these circumstances, the system 100 suppresses (e.g., masks, mutes, etc.) all sound in the nontarget area. It is contemplated that in another example, the system 100 extracts sound from the nontarget area and suppresses all sound in the target area 102. It is further noted that the system 100 can be run locally as shown and/or leverage cloud computing where appropriate.

In the illustrated example, the system 100 is shown as a laptop computer but can be any computing system. Components of the system 100 are shown and exaggerated in Feature A for illustration purposes. As seen in feature A, the system 100 includes one or more processors 106 in communication with a storage 108 and instructions 110 that can be used to cause the processor 106 to perform certain actions. The storage 108 can be a non-transitory computer-readable medium. The processor 106 is further in communication with a machine learning model 111 (e.g., a deep neural network or “DNN”). The machine learning model 111 includes an extractor module 112, a steering module 114, and a collection module 116. In examples, the extractor module 112 can be used to extract sound from a designated area (e.g., the coverage area 104, the target area 102, or the nontarget area) and/or to suppress sound in the designated area. In examples, the steering module 114 can be used to redefine (e.g., rotate or shift) the target area 102 and/or adjust the dimensions (e.g., grow or shrink the dimensions) of the target area 102. In examples, the collection module 116 can be used to store, suppress, and/or mix (e.g., gain, filter, or otherwise modify) sound. Some or all of the sound to be mixed may be extracted by the extractor module 112.

Several different types of sound sources are illustrated in FIG. 1, each of which can be subject to a target area 102 that is defined by the system 100. In more detail, there is a meeting in a room with several sound sources, including a teleconference participant 118, an in-person conference table 120 with multiple participants, and an audio system 122 for the room. For discussion purposes, each of the sound sources is shown simultaneously emitting sound in the room. In other examples, the emitted sound may be staggered, intermittent, or otherwise blended. Divider lines 124, 126, 128, 130 are shown as example bounds for the target area 102 and are not meant to be limiting. For instance, the target area 102 can be defined between 124 and 126; 126 and 128; 128 and 130; 124 and 128; 126 and 130; and 124 and 130. It is contemplated that there may be examples where multiple target areas are defined within the coverage area 104, for instance between 124 and 126 as well as between 128 and 130.

Principles of the present disclosure include suppressing certain sounds within the target area 102. For instance, extracting sound from the target area 102 can consider (i) a number of target speakers, (ii) a number of interfering speakers that interfere with the target speakers, and (iii) background noise. Thus, there can be several “extraction modes” for extracting sound from the target area 102. A first extraction mode can be a single target speaker with one or more interfering speakers and removal of background noise. A second extraction mode can be multiple target speakers within the target area 102 with no interfering speakers and removal of background noise. A third extraction mode can be a single target speaker, a single interfering speaker, and no removal of background noise. And so on and so forth.

Further, the target area 102 can be moved to follow a target speaker. As the target speaker moves within the coverage area 104 relative to the microphone array from which the target area 102 emanates, the machine learning model 111 can redefine the target area to ensure that the speaker stays within the target area 102. As discussed elsewhere herein, the redefining can occur by applying a phase shift (e.g., phase shift in frequency domain and/or delaying in time domain) to captured audio. This audio can be captured via microphones, an array of microphones, or any other audio input devices. The phase shift can be based on a phase difference between each of the audio input devices in the plurality of audio input devices. The phase difference being based on both an incident angle of each of the audio input devices in the plurality of audio input devices and a distance therebetween. Aligning the target area 102 to the target speaker can aim to keep the target speaker at a centerline of the target area 102 within a given tolerance. It is contemplated that this alignment can, in addition or in alternative, keep the target speaker away from the boundaries of the target area 102 within a certain tolerance. Where there are multiple target areas 102 within the coverage area 104, each of the target areas 102 can be moved and aligned in this manner.

Dimensions of the target area 102 can be static or adjustable. The machine learning model 111 can generate an initial target area 102 at the onset of operation. Then, for instance, the machine learning model 111 can be trained with dimensions of a static target area 102 during training, and that target area 102 can be generated and redefined as necessary during operation. In another example, the machine learning model 111 can be trained with a range of dimensions that the target area 102 is allowed to grow or shrink during operation. In yet another example, the machine learning model 111 can be trained to intermittently grow or shrink the target area 102 (e.g., during inference of the machine learning model 111, at certain time intervals, or similar).

While depicted as conical, the target area 102 may take a variety of forms as one skilled in the art will appreciate. As noted elsewhere herein, the system 100 can have one or more audio input devices, such as a microphone. A microphone array having only two microphones experiences front-back ambiguities in sound localization. The machine learning model 111 can account for such ambiguities. More microphones in the microphone array can help resolve these ambiguities and lead to better localization. For instance, a microphone array of four microphones can allow three-dimensional localization. As the microphone array changes in size and shape, so too can the target area 102.

Further, operation of the system 100 may occur in one or more domains. For instance, the redefining can be performed in the frequency domain while suppression is performed in the time domain. On the other hand, the redefining can be performed in the time domain while suppression is performed in the frequency domain. It is also contemplated that the redefining and suppression can occur in the same domain, such as both in the time domain or both in the frequency domain.

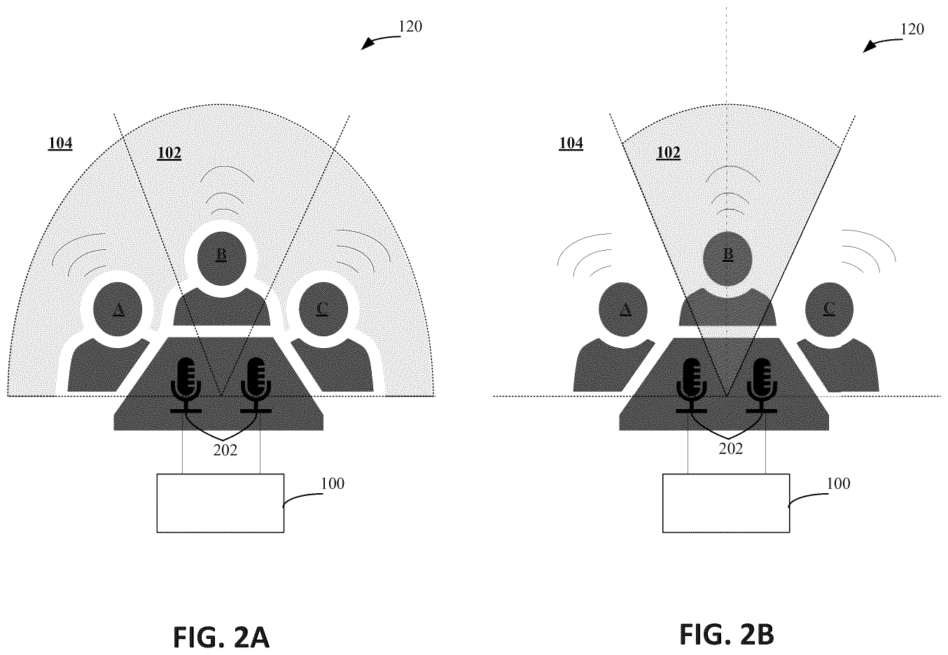

FIGS. 2A-2F show various characteristics of the target area 102 with the system 100 having stereo microphones 202 and performing at an in-person conference 120 with multiple participants (A, B, and C). This conference can be similar to that of FIG. 1 except that the sound sources are the participants only for discussion purposes. At the conference are Participants A-C, each of which is shown speaking for illustration purposes, though the system 100 can be used on any number of participants. In particular, FIG. 2A shows a target area 102 that is equal to the coverage area 104 and is situated around Participants A-C. FIG. 2B shows a target area 102 situated around an active speaker in Participant B. FIG. 2C shows a target area 102 that had been redefined from the position in FIG. 2B to now be situated around an active speaker in Participant C. FIG. 2D shows a target area 102 situated around active speakers in Participants A and B. FIG. 2E illustrates a redefined target area 102. 2F shows a target area 102 that has been increased in size over FIG. 2B.

These figures can show how the system 100 operates over time in a typical scenario involving a meeting held in a conference room with the system 100 and broadcasted to a virtual presentation. In this scenario, the coverage area 104 is equal to some or all of the conference room or at least an area that includes all speakers for the meeting. To begin, as presenters are gathering or introducing themselves together, the system 100 can operate in a conventional fashion shown in FIG. 2A where the target area 102 is equal to the coverage area 104 to capture audio from all presenters. As the meeting proceeds to where Participant B is the main presenter and target speaker, the target area 102 can be generated and situated about them as shown in FIG. 2B. The meeting progresses to have Participant C be the main presenter and target speaker in FIG. 2C. The meeting then progresses to have Participant B be the main presenter and target speaker again. FIG. 2E shows the target area 102 being redefined toward Participant B. And FIG. 2F shows the machine learning model 111 aligning the target area 102 with Participant B and growing the target area 102 to better accommodate the new speech from Participant B. In each of these scenarios, only sound from the target area 102 is extracted from the coverage area 104 (i.e., sound from the outside area is suppressed). If in FIG. 2E, Participants A and C have a sidebar conversation during Participant B's speech, their interfering speech as well as any background noise) can be suppressed when Participant B is the target speaker.

Also observable from FIG. 2F are parameters required to train the model on the target area 102 to be generated. For instance, a two-dimensional target area 102 can be defined using polar coordinates (e.g., a radius “R” and an angle “θ”) as shown. Where a three-dimensional target area 102 is used, a spherical coordinate system 100 can be used. In some instances, a two- or three-dimensional Cartesian coordinate system 100 can be used. As noted elsewhere herein, the system 100 can move or adjust the target area 102 by adjusting the appropriate parameters for the chosen system 100.

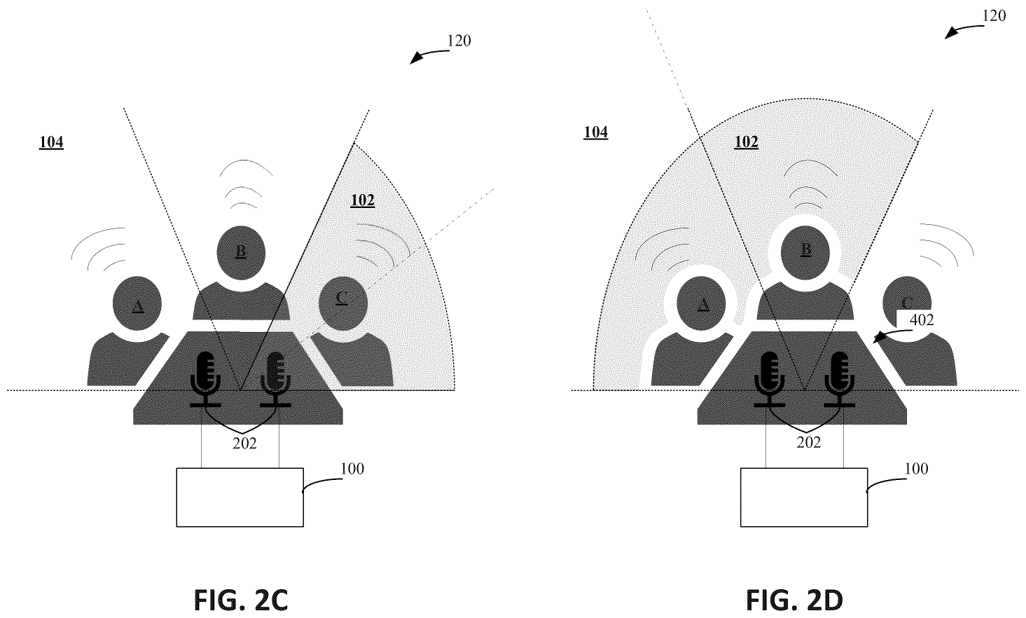

FIG. 3 shows the system 100 of FIG. 1 in communication with an external system 300. As is the case with FIG. 1, illustrated in FIG. 3 is a system 100 for extracting sounds from a coverage area. FIG. 3 also includes an external system 300 to which those extracted sounds can be transferred. The system 100 includes one or more processors in communication with a storage 108 and instructions 110 that can be used to cause the processor to perform certain actions. The processor is further in communication with a machine learning model 111 (e.g., a deep neural network or “DNN”).

The machine learning model 111 includes an extractor module 112, a redefining module 114, and a collection module 116. In examples, the extractor module 112 can be used to extract sound from a designated area (e.g., the coverage area, the target area, or the nontarget area) and/or to suppress sound in the designated area. In examples, the redefining module 114 can be used to redefine (e.g., rotate or shift) the target area and/or adjust the dimensions (e.g., grow or shrink the dimensions) of the target area. In examples, the collection module 116 can be used to store, suppress, and/or mix (e.g., gain, filter, or otherwise modify) sound. Some or all of the sound to be mixed may be extracted by the extractor module 112. The external system 300 includes a receiver 302 at which the extracted sounds are received. In examples, the external system 300 can be a computer, a server, or similar systems.

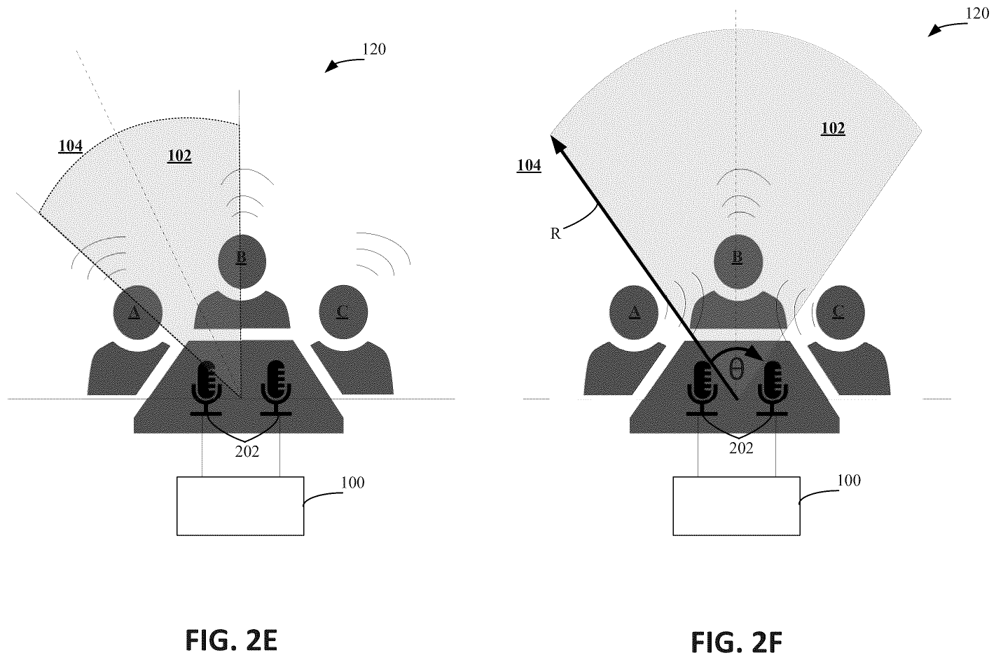

FIG. 4 is a flow chart of a method 400, according to an example of the present disclosure. According to an example, one or more method blocks of FIG. 4 may be performed by system 100.

As shown in FIG. 4, method 400 may include receiving speech or audio signals 402 from one or more audio sources in a plurality of audio sources within the coverage area. For example, system 100 may receive speech signals from one or more audio sources in a plurality of audio sources within the coverage area, as described above. As in addition shown in FIG. 4, method 400 may include defining a target area 404 that is a portion of the coverage area, the target area being definable by a trained criterion. For example, system 100 may define dimensions of a target area that is a portion of the coverage area, the target area being definable by a trained criterion, as described above.

As also shown in FIG. 4, method 400 may include adjusting or redefining the target area 406 to essentially move the target area toward the desired audio signals during a processing operation. As discussed here, the redefining of the target area may take small computational resources, while improving the computational efficiency of the system since lest information must be processed. For example, system 100 may adjust the target area toward the speech signals during a processing operation such that there is negligible additional computational cost, as described above.

As further shown in FIG. 4, method 400 may include extracting 408 the desired audio signals from the target area. For example, system 100 may extract desired speech signals from the target area, as described above. As in addition shown in FIG. 4, method 400 may include transmitting 410 the desired signal(s) to a receiver. For example, system 100 may transmit the desired speech signals to a receiver, as described above.

It should be noted that while FIG. 4 shows example operations of method 400, in some implementations, method 400 may include additional operations, fewer operations, different operations, or differently arranged operations than those depicted in FIG. 4. Additionally, or alternatively, two or more of the operations of method 400 may be performed in parallel.

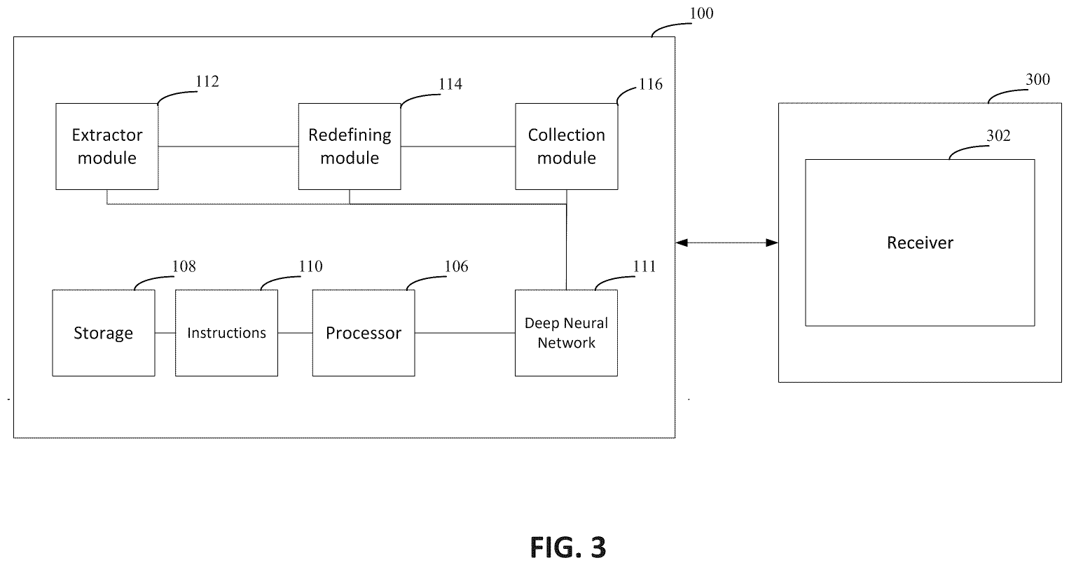

FIG. 5 is a flow chart of a method 500, according to an example of the present disclosure. Method 500 is another method for extracting sound from a target area arranged among a coverage area. According to an example, one or more method operations of FIG. 5 may be performed by system 100.

Method 500 begins by receiving 502 source separation criteria and receiving 504 sound source information for one or more active speakers. Then a target area is generated 506 within the coverage area using a model accessed by the system 100 for example. The target area is monitored 508 for active speakers. If there has been a change in sound source information 510 and the model is in inference 512 the target area is shifted 514 to include the sound source. But if the model is not in inference, the target area is monitored (block 508). After the target area is shifted (block 514) speech signals are extracted from the target area (block 516) and transmitted to a receiver (block 518). If the sound source information has not changed (block 510) speech signals are extracted from the target area (block 516) and transmitted to a receiver (block 518). The method can be continuously or intermittently run by an active system with active audio input devices.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

### Working Example 1

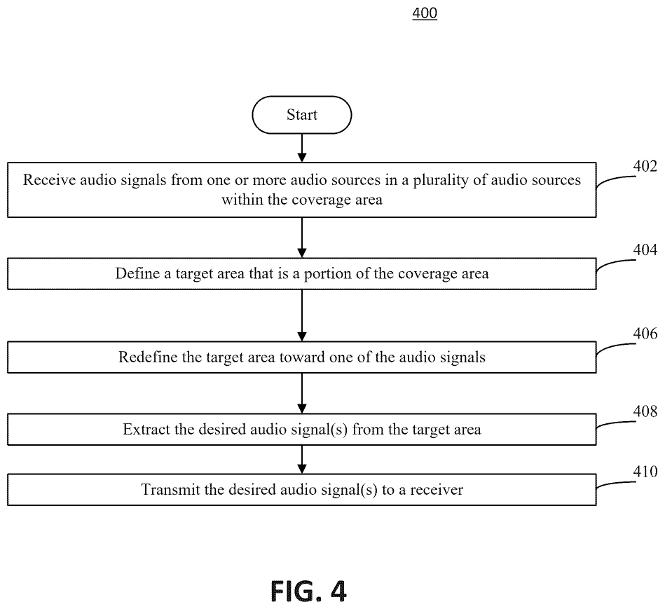

FIG. 6 is a diagram showing a progression of redefining a target area at stage (a) to stage (b). In particular, stage (a) can be used at setup to train the model for sound separation with a first speech source, and stage (b) shows a redefined target area that now includes a second speech source. Target speech sources are denoted by X, and interfering speech sources are denoted as Y. The target area is defined in part by the angle α.

To start, a first model for a laptop with stereo input is selected. This model is a real-time capable neural network operating in the STFT domain. More particularly, this model is a convolutional neutral network with a UNet architecture. As input, the STFT representation of the stereo input along the channel dimension is concatenated. Trained models generate a complex valued single channel separation mask, which is applied to the left channel of the input spectrum. The models are trained using an optimizer, such as a AdamW optimizer with a learning rate of 0.001, a weight decay of 2e-5 and the SI-SDR as loss function. The STFT computation used a square-root Hann window of 20 ms, hop size of 10 ms, and NFFT size of 320 points.

Overall, the model has approximately 640 k parameters with 9.18 billion floating point operations per second (GFLOPS) in terms of computational complexity. A real-time factor (RTF) of 0.04 was obtained, computing the average processing time of 100 files of 10 s length on a laptop with an 11th Gen. Intel® Core™ i7-1185G7 @ 3.00 GHz processor.

For a dataset, a synthetic dataset is created to simulate a defined scenario using a pyroomacoustics package. A ULA with two microphones is placed in a random position in a shoebox room. The room dimensions are uniformly sampled at [4.0 m×4.0 m×2.0 m] to [8.0 m×8.0 m×4.0 m] with T60 values randomly chosen between 0.25-0.7 s to simulate an office-like scenario. For simplicity, the microphone array and sources are assumed to be located at the same height. Non-overlapping speech and noise utterances from a DNS-Challenge dataset at a sampling rate of 16 kHz are used for training and validation. To avoid potential issues with front-back ambiguity using ULAs, no source is placed in a corresponding mirrored area along the microphone array.

Each generated clip is 10 s long and includes one target and one interfering speaker. A uniformly sampled signal-to-interference ratio (SIR) between 0-10 dB is used to mix the target and interfering speech utterances. Noise is added to the mix at a signal-to-noise ratio sampled from N (7, 3) distribution. Finally, the mix is level normalized by a value from N (−28, 10) dBFS. Overall, 55.6 h of training and 22.2 h of validation data are generated.

To understand the influence of the size of the target area to the source separation and redefining performance, 3 different versions of the first model, namely CNN20, CNN40 and CNN60, are trained with target area angles α={20°, 40°, 60° }respectively. For each version, the model configuration is the same but training and validation sets are different.

In a test setup, a separate test set using speech utterances from the 2020 Interspeech DNS-challenge test set are generated together with noise from FSDnoisy18k. Each test set contains 4 test scenarios, varying the amount of target and interfering speakers and either with or without additional background noise. Each test scenario includes 100 clips.

Performance is now evaluated using DNSMOS and SI-SDR as evaluation metrics. DNSMOS is a non-intrusive evaluation metric based on a neural network optimized to estimate the outcome of a P.808 listening test. It includes submetrics evaluating the signal quality (SIG), background (BAK), and overall quality (OVRL). SI-SDR is the metric that all models were optimized on. For all metrics, the improvement (Δ) compared to the input mixture signal is reported.

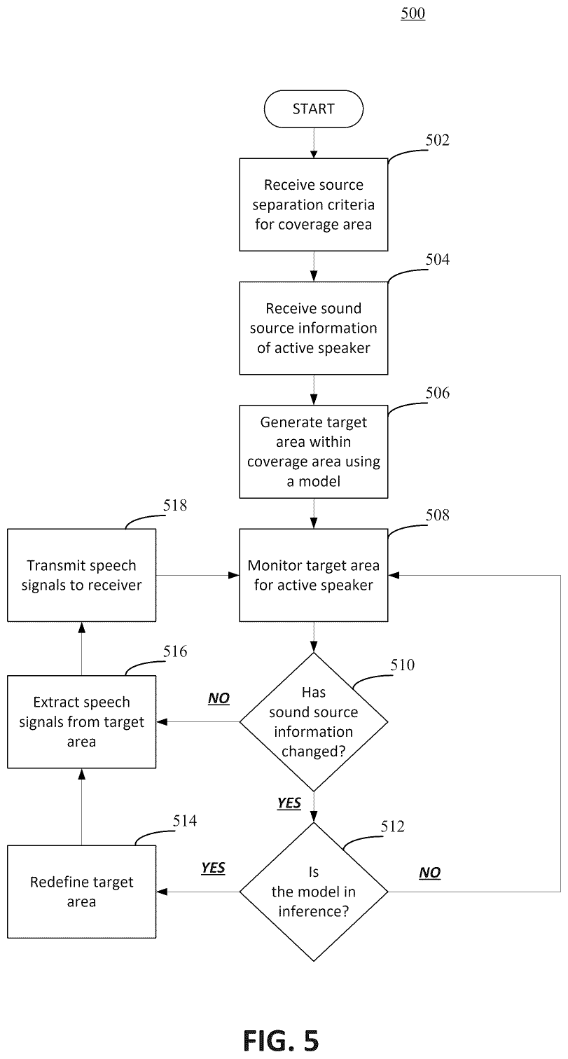

FIG. 7 shows power reduction heatmaps to visualize the effectiveness the models. In particular, shown is power reduction performance of CNN20 at different redefining angles relative to the microphone array. Power reduction is computed as the difference of mean power reduction in the target area and the area outside the target area. For this purpose, a single speech utterance is selected and placed along x and y direction in a pre-defined room. At each position, the power reduction metric is computed, i.e.,

$${PowerReduction}_{dB} := 10 {log}_{10} \frac{{‖ {y}_{m = 1} ‖}^{2}}{{‖ \hat{t} ‖}^{2}} , \qquad ( 9 )$$

where yₘ₌₁ and \hat{t} are the time domain representations of the mixture input signal at the reference microphone and the estimated target signal, respectively. Ideally, if the speech source is located outside the target area, the power reduction should be strong, while no reduction should take place when the speech source is inside the target area. This setup can be represented as a heatmap to visualize the ability of the model to cover the whole target area and how the target area changes after being redefined.

For results, discussion now turns to performance when the target area is redefined as seen in the power reduction heatmaps in FIG. 7. Here, FIG. 7 shows power reduction heatmaps of the trained CNN20 model at three different stages when no redefining is performed (Stage (a)), redefining the target area clockwise by 15° (Stage (b)), and redefining the target area clockwise by 30° (Stage (c)). The darker regions in the heatmaps denote stronger signal suppression. The dark solid lines indicate the initial target area, whereas lighter solid lines denote the redefined target. As it relates to these results, power reduction heatmaps were generated for a fixed room setting of [6.0 m×6.0 m×4.0 m] using CNN20 for redefining angles of 0° (i.e., no redefining), 15° and 30°. Due to front-back ambiguity, only one half of the room is shown because the other half is mirrored along the microphone array's x-axis. From these results, it is shown that an initial target area can be generated and successfully be redefined.

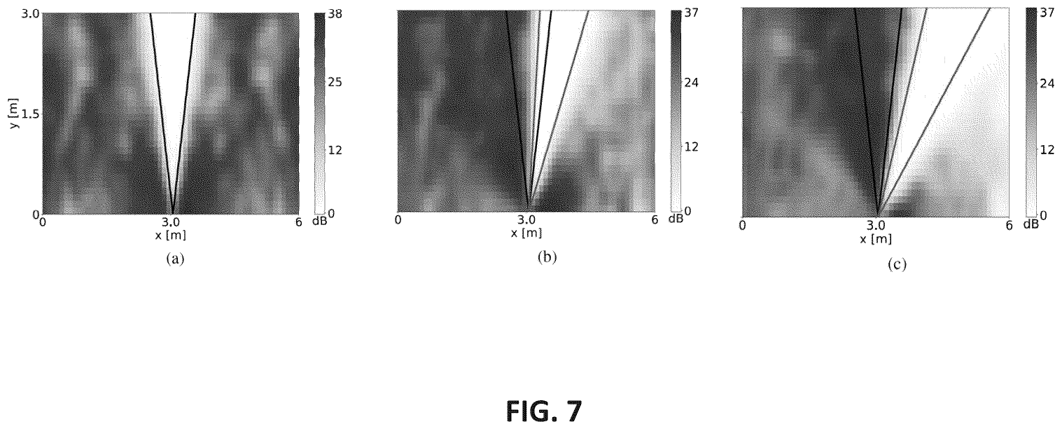

Continuing with results, performance of the target areas at different redefining angles is now evaluated with reference to FIG. 9. Shown here is a plot of a difference of mean power reduction in the target area and the area outside area against the redefining angle of the target areas for CNN20, CNN30, and CNN40 in five degrees steps. It can be seen that the power reduction is strongest for the initial learned target area and decreases with an increasing when redefined at a new angle with a peak between 35° and 45°. This likely occurs because there is no linear mapping of the target area with the angle but rather a non-linear change, increasing the area for larger angles. This effect can also be found in FIG. 7, where the white area indicating low suppression increases with an increasing redefining angle. Afterward, the power reduction increases again.

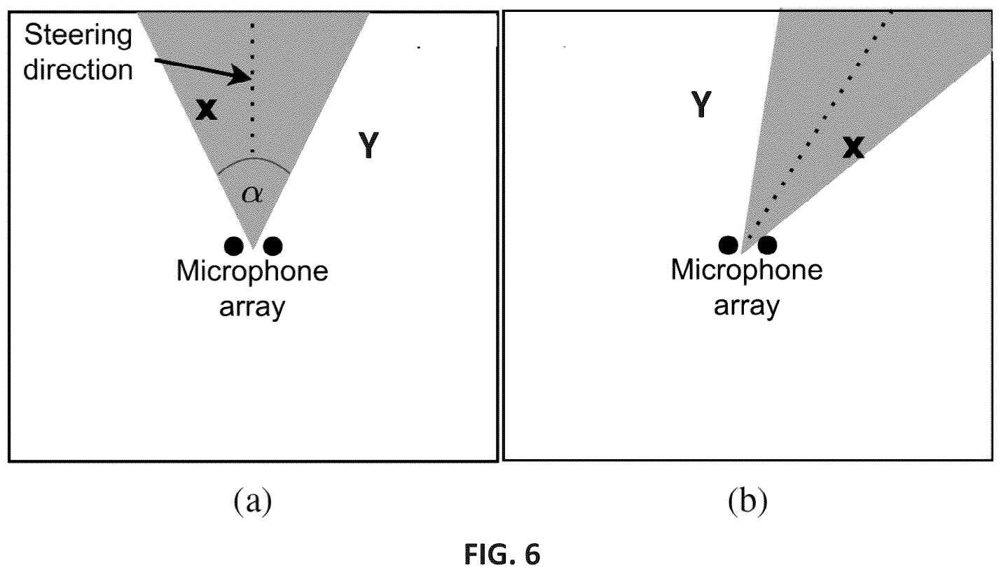

Last, performance of the model in terms of DNSMOS and SI-SDR metrics is evaluated via comparison to well-known Superdirective (SupDir) and MVDR beamforming approaches. With reference to the table shown in FIG. 8, CNN20, CNN40, and CNN 60 are evaluated at redefining angles of 25°, 45°, and 65°, respectively. It is ensured that the target sources are within the redefined target areas while the interfering sources remain within the initial target. This setup is also shown in FIG. 6. For the performance comparison, Superdirective and MVDR beamformers are redefined with the same angles. It must be noted that MVDR beamformer requires noise covariance matrix for its operation. For ‘without noise’ scenarios, a diagonal noise covariance matrix is used such that MVDR operates as delay-and-sum beamformer.

In general, all approaches show better improvements for the ‘with noise’ scenarios compared to the ‘without noise’ scenarios. This shows that they all have some degree of capability to suppress interfering noise. For ‘t1 k1’ scenarios, which indicates the presence of 1 target and 1 interfering speakers, MVDR and SupDir beamformers in general achieve the best ΔSIG for the conditions of ‘with noise’ and ‘without noise’, respectively. In general, MVDR performs better than SupDir for ‘with noise’ scenarios, whereas SupDir performs better than MVDR for ‘without noise’ scenarios. Overall, the CNN models present significantly better results compared to the well-know Superdirective and MVDR beamformers. Performance improvement achieved by CNN models are especially significant for ‘t23 k23’ scenarios, which indicates the presence of randomly selected 2 or 3 target speakers and randomly selected 2 or 3 interfering speakers.

### Working Example 2

A second model is an adaptation of a CNN developed for single-channel speech enhancement and trained on a complex compressed mean squared error (MSE) loss. To adapt the CNN, an initial convolution layer of a decoder was modified to receive stereo audio as input. Therefore, the STFT representations of each channel were concatenated along the channel dimension. In this way, the CNN was able to make use of the spatial information encoded in the multichannel microphone data. Note that no significant difference was found when explicitly modeling the inter-phase difference between the microphones.

The second model uses 4 symmetric convolution and transposed convolution layers in the UNet encoder and decoder structure respectively. A convolution kernel size of (2, 3) and stride of (1, 2) are used, effectively down-sampling and up-sampling a frequency dimension at convolution and transposed convolution layers, respectively. Skip connections are employed by using a trainable 1×1 convolutional layer to add the corresponding encoder output to the decoder output. At the bottleneck layer, 4 parallel grouped Gated Recurrent Unit (GRU) layers are used, which reduces the complexity and number of parameters of the second model. Each convolution and transposed convolution layers is followed with a PReLU function as non-linearity, except for the last transposed convolution layer, where a tanh activation function is used to produce a complex valued single channel separation mask.

As a training configuration, the models are trained with AdamW optimizer with a learning rate of 0.001 and a weight decay of 2e-5. For STFT computation, a square-root Hann window of 20 ms, hop size of 10 ms and NFFT size of 320 points are used. As loss function, SI-SDR is used between the target signal and network prediction.

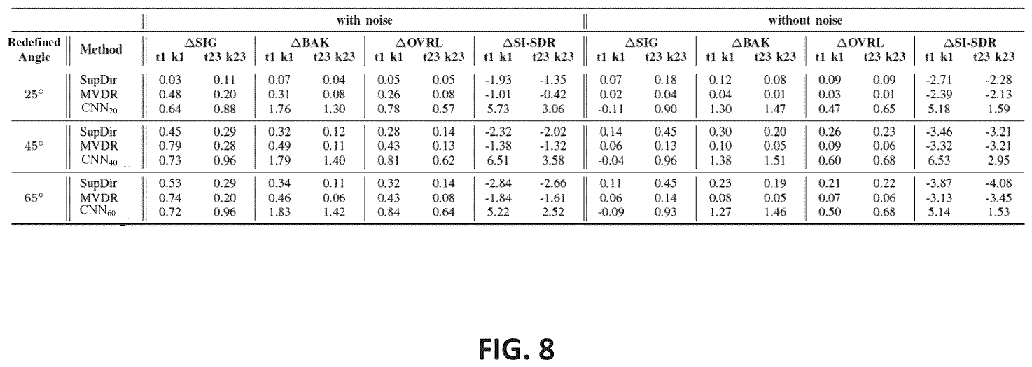

FIG. 10 illustrates a scenario, where the speech sources inside the angular target area with angle of α=60° is kept while suppressing interfering speakers and noise. Speech sources and noise are denoted by X and *, respectively.

A corresponding test setup uses a data set that is an offline synthetic dataset, including a train, validation, and test sets created for this experiment. A pyroomacoustics package is used to simulate virtual shoebox rooms of a randomly chosen size within [4.0 m×4.0 m×2.0 m] to [8.0 m×8.0 m×4.0 m]. T60 values are uniformly sampled at a range of 0.25-0.7 s, which are typical values that can be found in meeting rooms and offices. As microphone array, a ULA with two microphones and an inter-microphone distance of 0.08 m is defined. The array is randomly placed inside the generated room with at least 2 m distance from each wall and angular target area is created for an angle of α=60°. The train and validation sets include non-overlapping speech and noise utterances from the publicly available DNS-Challenge dataset.

Target and interfering speakers are mixed according to a SIR, which is uniformly sampled between 0-10 dB. Background noise is added to the speaker mix with a signal-to-noise-ratio (SNR) sampled from N (7, 3) distribution. All generated samples are level normalized with a value sampled at N (−28, 10) dBFS. A sampling rate of fs=16 kHz is used for the data generation.

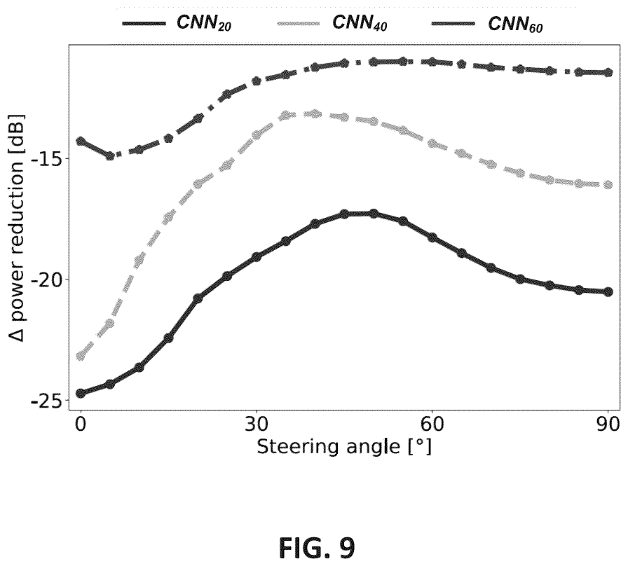

FIG. 11 shows an experimental setup of the different test scenarios with a mixture of target t and interfering sources k. random indicates random sampling for the number of speakers, source positions, and SIRs.

Two versions of the dataset are created for use in this setup. First is a simple (s) version including 1 target and 1 interfering speaker for each individual room. Second is a complex (c) data setup, where the number of speakers placed inside and outside the ROI is between 1-4 and sampled uniformly for each room. Consequently, one room contains at maximum 8 speech sources. To avoid problems with front-back ambiguity using ULAs, it is ensured to not place an interfering or target speech source in the corresponding mirrored area along the microphone array. From each audio file, a 10 s utterance is randomly extracted. In case the file was shorter than 10 s, it is padded with zeros to reach the desired length. Overall, the train and validation sets include approximately 55.6 h and 22.2 h of data, respectively.

For analysis, several variations of the model are employed. Here, CNNᵢ and CNNₕ are models with lightweight (l) and heavyweight (h) configurations, where the number of filters in the convolutional layers are set to [32, 64, 64, 64] and [32, 64, 128, 256], respectively. Moreover, s and c subscripts denote if the architectures are trained with simple or complex data setup, respectively.

As a well-established baseline method, a standard Conv-TasNet model is trained on stereo input by increasing the input channel dimension in the encoder part of the network. The model applies a real-valued separation mask to a learned feature representation to estimate the combined utterances in the target area. This model is trained to maximize the SI-SDR with the complex data setup.

To evaluate the performance, a set of test scenarios are created as illustrated in FIG. 11. The speech files for the test data are taken from the 2020 Interspeech DNS-challenge test set with noise from FSDnoisy18k. Scenarios 1 and 2 consider the influence of different amounts of speakers with and without a noise source being present, respectively. Furthermore, the influence of different SIR is investigated for a single target (scenario 3) and multi-target (scenario 4) setup. Each test scenario includes 50 items for evaluation.

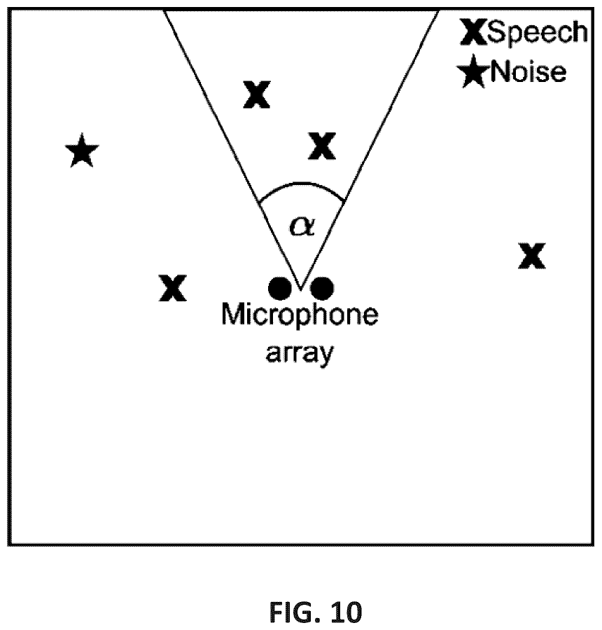

Model complexity can be observed from FIG. 12. Here, the CNNs are compared in terms of numbers of parameters, floating-point operation (FLOPs) and real-time factor (RTF). The RTF numbers are the average processing time for 100 files of 10 s length on a laptop with a 11th Gen. Intel® Core™ i7-1185G7 @ 3.00 GHz. It can be seen that Conv-TasNet is by far the most complex architecture compared CNNᵢ and CNNₕ in terms of GFLOPS and RTF. CNNₗ shows an approximately six times smaller amount of GFLOPS and two times lower processing time compared to the heavy-weight CNNₕ architecture.

To evaluate the performance of the proposed approach, the SI-SDR and DNSMOS are used as performance metrics. DNSMOS is a non-intrusive quality metric used to estimate the outcome of a P.808 listening test. SI-SDR is a common metric to evaluate the signal quality, on which all models are also optimized with the loss function. A difference Δ of the computed metrics is calculated compared to the original input signal.

To show whether the model is able to cover the whole target area, a power reduction heatmap is generated. Therefore, a single source was placed around the room at a spacing of 0.2 m in x and y direction with a fixed setting and the power reduction metric was evaluated for each location, i.e.,

$${PowerReduction}_{dB} := 10 {log}_{10} \frac{{‖ {y}_{m = 1} ‖}^{2}}{{‖ \hat{t} ‖}^{2}} , \qquad ( 9 )$$

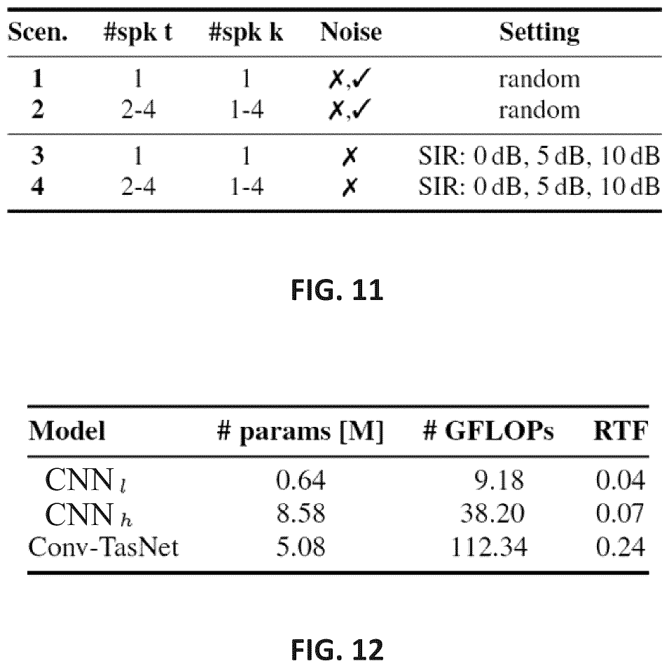

FIG. 13 shows a power reduction heatmap of an angular area with α=600 using the CNN_{c,l}. Note that due to front-back ambiguity for ULAs, only half the image is shown.

Ideally, if the source is located within the target area, the model outputs the unchanged signal with no power reduction. On the other hand, for each source located outside the target area a strong power reduction indicating a strong suppression of interfering sounds can be expected. The test room was set to a size of [12 m×12 m×2 m], with a T60=0.5 s and the microphone array was placed in the middle of the room.

FIG. 13 displays the power reduction heatmap using the CNN_{c,l}. The figure shows that the model is able to differentiate well between target area, with almost no power reduction, and the area outside the target area. The effect is slightly reduced with further distance to the microphone array, where sources close to the edge of the target area receive less suppression. It is worth mentioning that the heatmap visualization uses a larger room size that was never seen in training suggesting that this method can generalize well to larger setups.

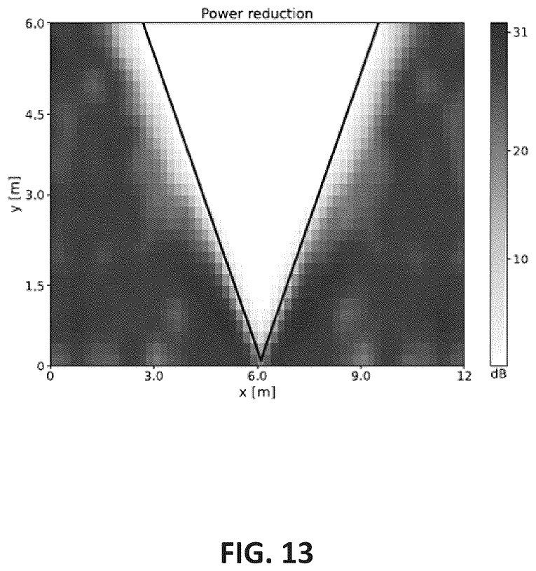

FIG. 14 shows DNSMOS and SI-SDR results (mean) for the test scenarios with a different number of speakers and with or without background noise. t and k represent target and interfering sources respectively. 1 denotes that a single source was present, 24 represent randomly sampled 2-4 speakers.

The results of test scenarios 1 and 2 are displayed in FIG. 14. Comparing the different CNN setups, it can be seen that CNN_{s,h} performs best in terms of DNSMOS among all scenarios before CNN_{s,l}. These results suggest that it is sufficient to use a simple data setup to cover the target area for separation. The SI-SDR value of models with a simple data setup drop in the multi-target scenario without noise, showing a discrepancy between this metric and the DNSMOS values. The corresponding test samples show that those two models struggle to retain all target utterances for a small amount of test items, including multiple target speakers. This leads to a negative delta and a lower average value overall. CNN_{c,h} and CNN_{s,h} perform slightly better than their corresponding light-weight version in most settings. This indicates that a larger CNN can reach better values, at the cost of higher computational complexity.

Compared to Conv-TasNet, it can be seen that CNN_{s,l} and CNN_{s,h} perform better in a multi-target speaker setting in terms of the DNSMOS metric, while Conv-TasNet shows slightly better results for a single target speaker. However, it is worth emphasizing that Conv-TasNet is the most complex model, which operates on more than ten times the amount of computational operations. Although Conv-TasNet shows lower DNSMOS values in the multi-speaker setup, it performs best in terms of SI-SDR in all settings. Inspecting a few of the respective separated items reveal strong distortion-like artifacts in the generated samples for Conv-TasNet. This explains the low DNSMOS values in part. Overall, considering perceptual quality and computational complexity the obtained results suggest CNN_{s,h}.

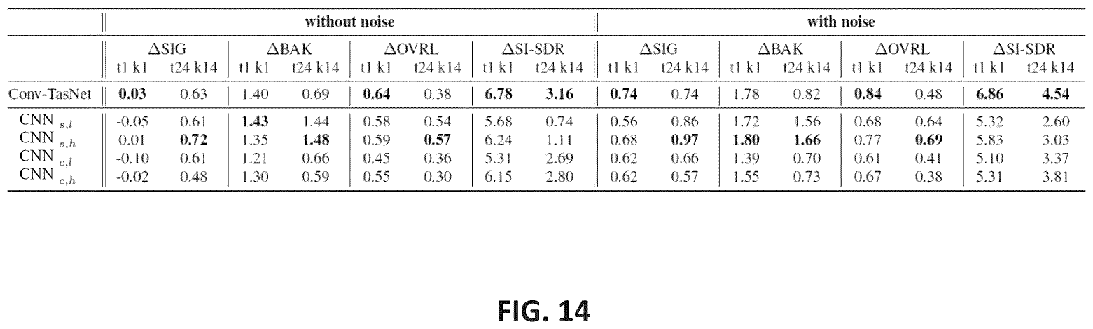

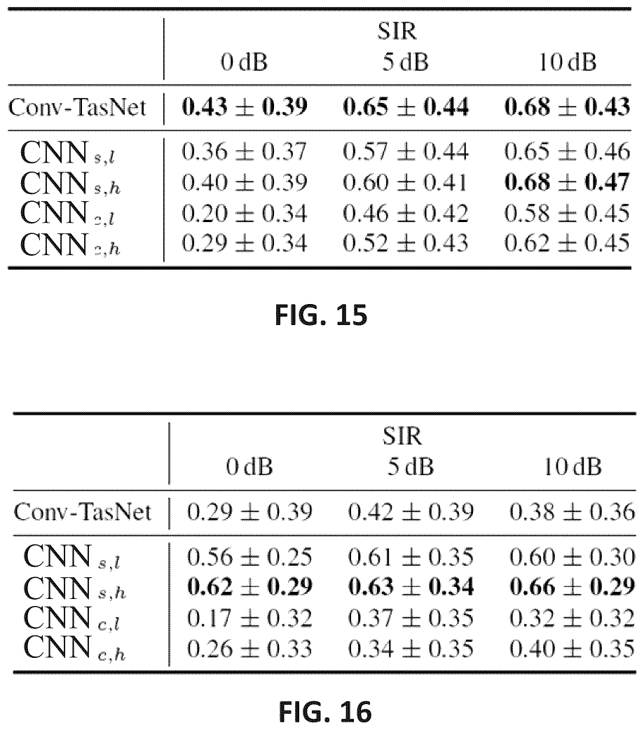

The results for different SIRs in test scenarios 3 and 4 are displayed in FIGS. 15 and 16. FIG. 15 shows ΔOVRL (mean±std) of DNSMOS for different SIRs using 1 target and 1 interfering speaker without noise source. FIG. 16 shows ΔOVRL (mean±std) of DNSMOS for different SIRs using multiple target and interfering speaker without noise source.

Only the ΔOVRL of DNSMOS is reported here, however the overall trend remains the same for the other DNSMOS metrics. Both FIGS. 15 and 16 demonstrate that an increasing SIR leads to an increased performance, which is somewhat predictable as the utterances placed inside the target area become more dominant in the mixture. Looking at the multi-target scenario at 10 dB no further gain is achieved compared to 5 dB for Conv-TasNet and the light-weight CNN. This suggests that in a complex scenario of several target and several interfering speakers, the effect of a higher SIR decreases. Overall, the results displayed in FIG. 15 and FIG. 16 largely confirm the results from FIG. 14 with Conv-TasNet showing the strongest results with a single target speaker, but CNN_{s,h} being best in a multi-target speaker setup.

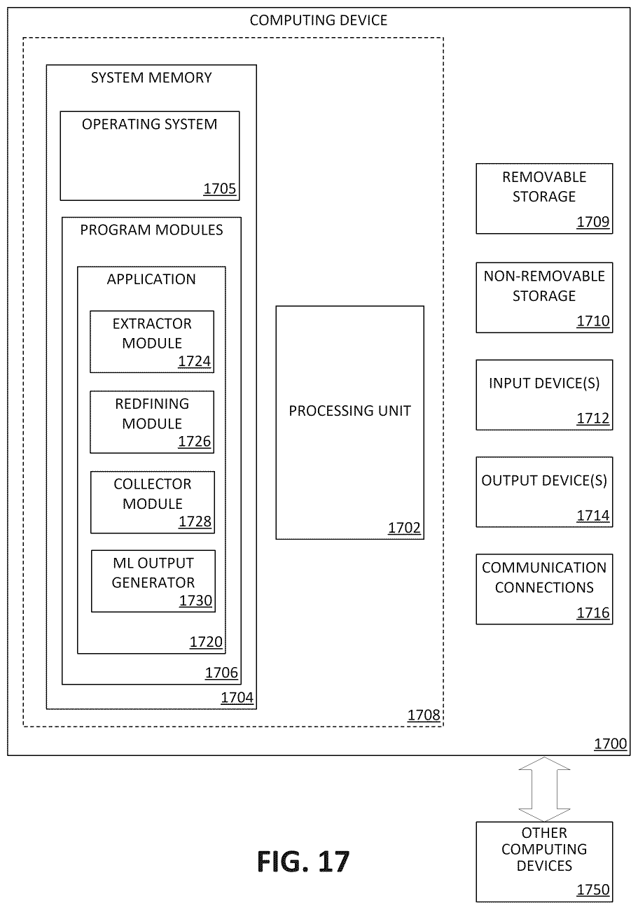

FIGS. 17-19 and the associated descriptions provide a discussion of a variety of operating environments in which aspects of the disclosure may be practiced. However, the devices and systems illustrated and discussed with respect to FIGS. 17-19 are for purposes of example and illustration and are not limiting of a vast number of computing device configurations that may be utilized for practicing aspects of the disclosure, described herein.

FIG. 17 is a block diagram illustrating physical components (e.g., hardware) of a computing device 1700 with which aspects of the disclosure may be practiced. The computing device components described below may be suitable for the computing devices described above, including one or more devices associated with a machine learning service, as well as computing devices (e.g., system 100) discussed above with respect to FIG. 1. In a basic configuration, the computing device 1700 may include at least one processing unit 1702 and a system memory 1704. Depending on the configuration and type of computing device, the system memory 1704 may comprise, but is not limited to, volatile storage (e.g., random access memory), non-volatile storage (e.g., read-only memory), flash memory, or any combination of such memories.

The system memory 1704 may include an operating system 1705 and one or more program modules 1706 suitable for running software application 1720, such as one or more components supported by the systems described herein. As examples, an application 1720 (e.g., service application) may run various modules to perform functionalities described herein, such as an extractor module 1724, redefining module 1726, a collector module 1728, an/or a ML output generator 1730. These modules can be similar to those similar modules discussed elsewhere herein. The operating system 1705, for example, may be suitable for controlling the operation of the computing device 1700.

Furthermore, embodiments of the disclosure may be practiced in conjunction with a graphics library, other operating systems, or any other application program and is not limited to any particular application or system. This basic configuration is illustrated in FIG. 17 by those components within a dashed line 1708. The computing device 1700 may have additional features or functionality. For example, the computing device 1700 may also include additional data storage devices (removable and/or non-removable) such as, for example, magnetic disks, optical disks, or tape. Such additional storage is illustrated in FIG. 17 by a removable storage device 1709 and a non-removable storage device 1710.

As stated above, a number of program modules and data files may be stored in the system memory 1704. While executing on the processing unit 1702, the program modules 1706 (e.g., application 1720) may perform processes including, but not limited to, the aspects, as described herein. Other program modules that may be used in accordance with aspects of the present disclosure may include metric monitors, definition databases, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 17 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1700 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 1700 may also have one or more input device(s) 1712 such as a keyboard, a mouse, a pen, a sound or voice input device, a touch or swipe input device, etc. The output device(s) 1714 such as a display, speakers, a printer, etc. may also be included. The aforementioned devices are examples and others may be used. The computing device 1700 may include one or more communication connections 1716 allowing communications with other computing devices 1750. Examples of suitable communication connections 1716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1704, the removable storage device 1709, and the non-removable storage device 1710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1700. Any such computer storage media may be part of the computing device 1700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

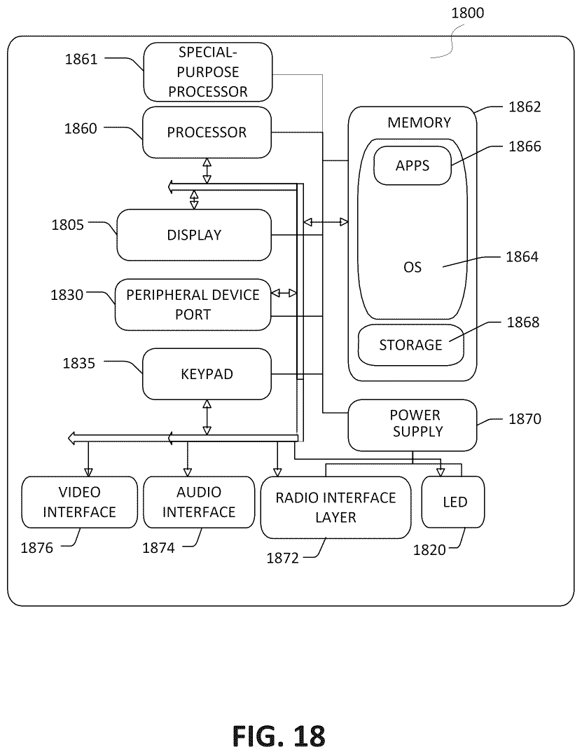

FIG. 18 illustrates a system 1800 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 1800 is implemented as a “smart phone” capable of running one or more applications (e.g., browser, e-mail, calendaring, contact managers, messaging clients, games, and media clients/players). In some aspects, the system 1800 is integrated as a computing device, such as an integrated personal digital assistant (PDA) and wireless phone.

In a basic configuration, such a mobile computing device is a handheld computer having both input elements and output elements. The system 1800 typically includes a display 1805 and one or more input buttons that allow the user to enter information into the system 1800. The display 1805 may also function as an input device (e.g., a touch screen display).

If included, an optional side input element allows further user input. For example, the side input element may be a rotary switch, a button, or any other type of manual input element. In alternative aspects, system 1800 may incorporate more or less input elements. For example, the display 1805 may not be a touch screen in some embodiments. In another example, an optional keypad 1835 may also be included, which may be a physical keypad or a “soft” keypad generated on the touch screen display.

In various embodiments, the output elements include the display 1805 for showing a graphical user interface (GUI), a visual indicator (e.g., a light emitting diode 1820), and/or an audio transducer 1825 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 1866 may be loaded into the memory 1862 and run on or in association with the operating system 1864. Examples of the application programs include phone dialer programs, e-mail programs, personal information management (PIM) programs, word processing programs, spreadsheet programs, Internet browser programs, messaging programs, and so forth. The system 1800 also includes a non-volatile storage area 1868 within the memory 1862. The non-volatile storage area 1868 may be used to store persistent information that should not be lost if the system 1800 is powered down. The application programs 1866 may use and store information in the non-volatile storage area 1868, such as e-mail or other messages used by an e-mail application, and the like. A synchronization application (not shown) also resides on the system 1800 and is programmed to interact with a corresponding synchronization application resident on a host computer to keep the information stored in the non-volatile storage area 1868 synchronized with corresponding information stored at the host computer. As should be appreciated, other applications may be loaded into the memory 1862 and run on the system 1800 described herein.

The system 1800 has a power supply 1870, which may be implemented as one or more batteries. The power supply 1870 might further include an external power source, such as an AC adapter or a powered docking cradle that supplements or recharges the batteries.

The system 1800 may also include a radio interface layer 1872 that performs the function of transmitting and receiving radio frequency communications. The radio interface layer 1872 facilitates wireless connectivity between the system 1800 and the “outside world,” via a communications carrier or service provider. Transmissions to and from the radio interface layer 1872 are conducted under control of the operating system 1864. In other words, communications received by the radio interface layer 1872 may be disseminated to the application programs 1866 via the operating system 1864, and vice versa.

The visual indicator 1820 may be used to provide visual notifications, and/or an audio interface 1874 may be used for producing audible notifications via the audio transducer 1825. In the illustrated embodiment, the visual indicator 1820 is a light emitting diode (LED) and the audio transducer 1825 is a speaker. These devices may be directly coupled to the power supply 1870 so that when activated, they remain on for a duration dictated by the notification mechanism even though the processor 1860 and other components might shut down for conserving battery power. The LED may be programmed to remain on indefinitely until the user takes action to indicate the powered-on status of the device. The audio interface 1874 is used to provide audible signals to and receive audible signals from the user. For example, in addition to being coupled to the audio transducer 1825, the audio interface 1874 may also be coupled to a microphone to receive audible input, such as to facilitate a telephone conversation. In accordance with embodiments of the present disclosure, the microphone may also serve as an audio sensor to facilitate control of notifications, as will be described below. The system 1800 may further include a video interface 1876 that enables an operation of an on-board camera 1830 to record still images, video stream, and the like.

It will be appreciated that system 1800 may have additional features or functionality. For example, system 1800 may also include additional data storage devices (removable and/or non-removable) such as, magnetic disks, optical disks, or tape. Such additional storage is illustrated in FIG. 18 by the non-volatile storage area 1868.

Data/information generated or captured and stored via the system 1800 may be stored locally, as described above, or the data may be stored on any number of storage media that may be accessed by the device via the radio interface layer 1872 or via a wired connection between the system 1800 and a separate computing device associated with the system 1800, for example, a server computer in a distributed computing network, such as the Internet. As should be appreciated, such data/information may be accessed via the radio interface layer 1872 or via a distributed computing network. Similarly, such data/information may be readily transferred between computing devices for storage and use according to any of a variety of data/information transfer and storage means, including electronic mail and collaborative data/information sharing systems.

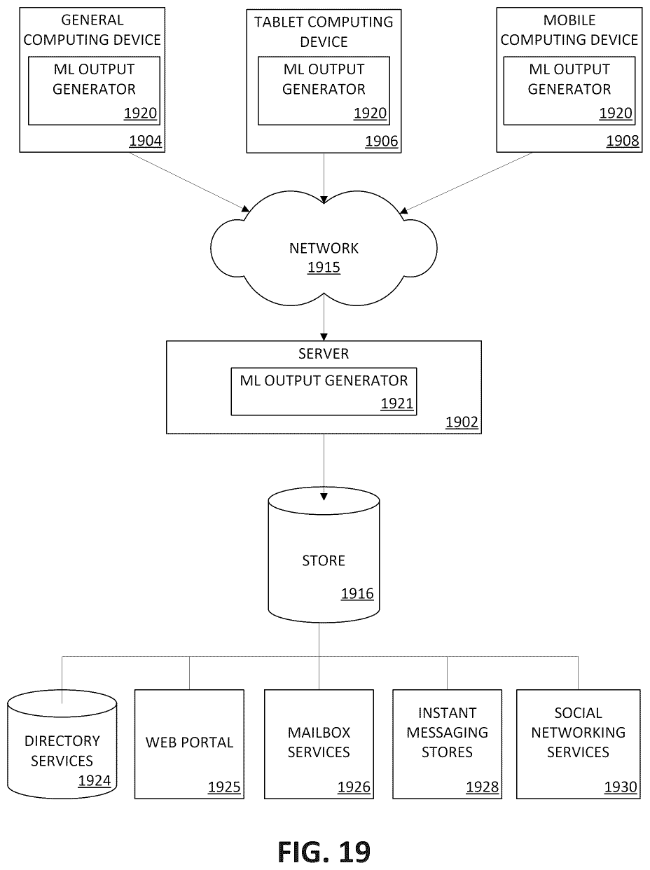

FIG. 19 illustrates one aspect of the architecture of a system for processing data received at a computing system from a remote source, such as a personal computer 1904, tablet computing device 1906, or mobile computing device 1908, as described above. Content displayed at server device 1902 may be stored in different communication channels or other storage types. For example, various documents may be stored using a directory service 1924, a web portal 1925, a mailbox service 1926, an instant messaging store 1928, or a social networking site 1930.

A ML output generator 1920 (e.g., similar to application 1720) may be employed by a client that communicates with server device 1902. Additionally, or alternatively, ML output generator 1921 may be employed by server device 1902. The server device 1902 may provide data to and from a client computing device such as a personal computer 1904, a tablet computing device 1906 and/or a mobile computing device 1908 (e.g., a smart phone) through a network 1915. By way of example, the computer system described above may be embodied in a personal computer 1904, a tablet computing device 1906 and/or a mobile computing device 1908 (e.g., a smart phone). Any of these examples of the computing devices may obtain content from the store 1916, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method of extracting sound from a coverage area having a system with at least one audio input device, the method comprising:
receiving speech signals from one or more audio sources in a plurality of audio sources within the coverage area;
defining a target area that is a portion of the coverage area, the target area being definable by a trained criterion;
redefining the target area to include the speech signals during a processing operation such that there is negligible additional computational cost;
extracting the speech signals from the target area; and
transmitting the speech signals to a receiver.

2. The method of claim 1, wherein the defining the target area that is a portion of the coverage area is performed by a machine learning model, and wherein the processing operation is during inference of the machine learning model.

3. The method of claim 1, wherein the trained criterion includes dimensions of the target area.

4. The method of claim 3, wherein the dimensions are defined in polar coordinates such that the target area is in the form of a circular sector.

5. The method of claim 4, wherein the receiving the speech signals from the one or more audio sources in the plurality of audio sources within the coverage area is performed via the at least one audio input device, and wherein the circular sector is centered at the at least one audio input device.

6. The method of claim 1, wherein the redefining the target area toward the speech signals during the processing operation includes aligning a target area centerline of the target area to an audio source center point of the one or more audio sources that are producing the speech signals.

7. The method of claim 1, wherein the receiving the speech signals from the one or more audio sources in the plurality of audio sources within the coverage area is performed via the at least one audio input device.

8. The method of claim 7, wherein the redefining the target area toward the speech signals during the processing operation includes is performed via a phase shift to the at least one audio input device.

9. The method of claim 7, wherein the at least one audio input device includes a microphone array having a plurality of audio input device, and wherein the microphone array is provided by a laptop computer.

10. The method of claim 1, further comprising mixing the extracted speech signals.

11. The method of claim 1, wherein the extracting the speech signals from the target area forms extracted speech signals, the method further comprising mixing the extracted speech signals.

12. The method of claim 11, wherein the mixing includes at least one of masking and muting the extracted speech signals.

13. The method of claim 1, wherein the extracting the speech signals from the target area includes suppressing all speech signals from outside the target area.

14. The method of claim 13, wherein the extracting the speech signals from the target area further includes suppressing at least one of interfering speech signals and background does from the speech signals within the target area.

15. A system for extracting speech signals from a coverage area, the system comprising:
one or more computing systems, each of the computing systems having:
a processor;
a storage in communication with the processor; and
a plurality of audio input devices,
the one or more computing systems being configured to:
receive speech signals from one or more audio sources in a plurality of audio sources within the coverage area;
define a target area that is a portion of the coverage area, the target area being definable by a trained criterion;
redefine the target area to include the speech signals during a processing operation such that there is negligible additional computational cost;
extract the speech signals from the target area; and
transmit the speech signals to a receiver.

16. The system of claim 15, wherein the target area is defined via a machine learning model, and wherein the processing operation is during inference of the machine learning model.

17. The system of claim 16, wherein the target area is redefined by the machine learning model performing a phase shift to at least one audio input device in the plurality of audio input devices.

18. The system of claim 17, wherein the target area is defined as a circular sector centered about the plurality of audio input devices, and wherein the phase shift is based on a phase difference between each audio input devices in the plurality of audio input devices, the phase difference being based on both an incident angle of each of the audio input devices in the plurality of audio input devices and a distance therebetween.

19. A non-transitory computer-readable medium comprising instructions that, when executed by at least one processor, cause the at least one processor to:
receive speech signals from one or more audio sources in a plurality of audio sources within a coverage area;
define a target area that is a portion of the coverage area, the target area being definable by a trained criterion;
redefine the target area to include the speech signals during a processing operation such that there is negligible additional computational cost;
extract the speech signals from the target area; and
transmit the speech signals to a receiver.

20. The non-transitory computer readable medium of claim 19, wherein the speech signals are acquired by a plurality of audio input devices, and wherein the target area is adjusted by performing a phase shift on the speech signals using a short-time Fourier transform representation of the plurality of audio input devices.
